(19) United States
(12) Patent Application Publication
(10) Pub. No.: US 2010/0295305 A1
(43) Pub. Date: Nov. 25, 2010

(54) WIND TURBINE AND CONTROL SYSTEM

(75) Inventor: Imad Mahawili, Grand Haven, MI (US)

Correspondence Address: VAN DYKE, GARDNER, LINN & BURKHART, LLP, SUITE 207, 2851 CHARLEVOIX DRIVE, S.E., GRAND RAPIDS, MI, 49546, US

(73) Assignee: E-NET, LLC, Grand Haven, MI (US)

(21) Appl. No.: 12/714,982

(22) Filed: Mar. 1, 2010

Related U.S. Application Data
(60) Provisional application No. 61/179,903, filed on May 20, 2009.

(51) Int. Cl. F03D 7/04

(52) U.S. Cl. 290/44

(57) ABSTRACT

A wind turbine system for generating electricity includes a turbine and a control system for managing the electricity generated by the turbine. The control system may include sensors for determining wind direction and wind speed and a controller that rotates the turbine into the wind if the wind speed is less than a threshold and out of the wind if the wind speed exceeds a threshold. The control system may also be adapted to supply electricity to one or more circuits within a home or residence. The electricity harvested from the turbine may be transferred by the control system to one or more batteries, or it may be transferred to the circuits within the residence. The electrical power extracted from the wind turbine may be harvested in a continuous manner, a pulsed manner, or a hybrid manner based upon control of the input impedances into the control circuit of subsystem.

### CROSS-REFERENCE TO RELATED APPLICATIONS

This application claims priority to U.S. provisional patent application Ser. No. 61/179,903 filed May 20, 2009 by applicant Imad Mahawili and entitled Wind Turbine and Control System, the complete disclosure of which is hereby incorporated herein by reference.

### BACKGROUND OF THE INVENTION

The present invention relates generally to a wind turbine and, more particularly, to the control system that harvests the electrical energy generated by the wind turbine and that controls various aspects of the wind turbine.

Conventional wind turbines typically do not utilize the energy present in low speed winds that could otherwise be converted to electrical energy. Conventional wind turbines also tend to be relatively expensive; difficult to install, maintain, and operate; and not easily integrated into the electrical system of a residential or small business setting. Conventional wind turbines may also become damaged if the wind speeds are excessive.

### SUMMARY OF THE INVENTION

The various embodiments of the present invention substantially mitigate one or more of the disadvantages noted above. In some embodiments, the present invention provides a wind turbine and control system that automatically controls the orientation of the wind turbine and the generation of electrical power therefrom in such a manner so as to avoid damage to the wind turbine and to increase the efficiency of the wind turbine system. The wind turbine system is easy to install in residential and similar type settings and may incorporate one or more conventional parts, such as automobile batteries, to reduce the cost of the overall system. The wind turbine is also adapted to generate power in low wind conditions, which may be used for charging one or more batteries, or supplied to a load, or both.

According to one embodiment, a system for generating electricity from wind is provided. The system includes a wind turbine and a control subsystem for the wind turbine. The wind turbine includes a plurality of blades adapted to rotate about an axis and to thereby generate an output voltage. The wind turbine has an electrical impedance and the control subsystem has a variable impedance controlled by a controller. The controller extracts power from said wind turbine in a pulsed manner by changing the variable impedance of the control subsystem between levels that are below and above the electrical impedance of said wind turbine.

According to another embodiment, a system for generating electricity from wind is provided. The system includes a wind turbine and a control subsystem. The wind turbine includes a plurality of blades adapted to rotate about an axis and to thereby generate an output voltage. The control subsystem extracts electrical power from the wind turbine in a substantially continuous manner when the wind speed is less than a wind speed threshold, and the control subsystem extracts electrical power from the wind turbine in a pulsed manner when the wind speed is greater than the wind speed threshold.

According to another embodiment, a control system for a wind turbine having a plurality of blades adapted to rotate about an axis is provided. The control system includes a first sensor, a second sensor, a motor, and a controller. The first sensor determines wind direction; the second sensor determines wind speed; and the motor is adapted to change an orientation of the rotational axis of the wind turbine. The controller is in communication with the first and second sensors and adapted to activate the motor such that the axis aligns with the wind direction when the wind speed is less than a threshold. The controller is further adapted to activate the motor such that the axis is misaligned with the wind direction when the wind speed is greater than the threshold.

According to another embodiment, a system for generating electricity from wind power is provided. The system includes a wind turbine, a voltage sensor, a buck converter, an inverter, a transfer switch, a battery, and a controller. The wind turbine includes a plurality of blades adapted to rotate about an axis and generate a voltage output. The voltage sensor measures the voltage of the output from the wind turbine. The buck converter is in electrical communication with the wind turbine voltage output and is adapted to reduce the voltage level of the wind turbine voltage output. The inverter is adapted to convert direct current into alternating current. The transfer switch selectively couples either an output of the inverter or a utility-supplied source of electrical energy to a distribution panel in the residence or business setting to which the wind turbine is supplying electrical energy. The controller is in communication with the voltage sensor, the buck converter, the battery, and the transfer switch. The controller is adapted to monitor the charge level of the battery and to switch the transfer switch to couple the utility-supplied source of electrical energy to the distribution panel when the charge level of the battery falls below a charge threshold and the output voltage falls below a voltage threshold.

According to other aspects of the invention, the second sensor may be an anemometer physically spaced away from the wind turbine blades, or it may be one or more sensors adapted to measure a speed of the plurality of blades. The controller may further be adapted to activate the motor such that the amount of misalignment between the axis and the wind direction increases as the wind speed increases above the threshold. The voltage regulator may be adapted to supply a regulated voltage to the inverter and one or more batteries. The blades of the wind turbine may have a profile that occupies a relatively large portion of the circular area defined by the rotation of the blades, such as 50% or more, although other levels of solidity may be used. The wind turbine itself may include a plurality of magnets mounted adjacent an outer end of the plurality of blades. The controller may be adapted to automatically couple the battery to the distribution panel upon detecting a loss of utility-supplied power. The controller may also be configured to monitor a charge level of the battery and prevent the battery from experiencing a deep cycle discharge except when the controller detects a loss in the utility-supplied power. The controller may re-charge the battery by applying a substantially constant current to the battery until a threshold level of charge is reached and thereafter supply a substantially constant voltage to the battery after the threshold level of charge is reached. The battery may be a conventional automobile battery, or a plurality of conventional automotive batteries electrically coupled together in any suitable manner. The control subsystem may change its electrical impedance in a pulsed manner that alternates between slowing the wind turbine down to a low speed threshold and allowing the wind turbine to regain speed up to an upper speed threshold, and which repeats in a like manner.

In still other embodiments, the controller may be adapted to transmit electricity generated by the wind turbine directly to the inverter if the level of voltage generated by the wind turbine exceeds a voltage threshold. The inverter may be configured to convert direct current into alternating current having a voltage of substantially 120 volts so that the voltage may be supplied directly to residences and business in North American homes or small businesses. In other embodiments, the inverter may be configured to convert the direct current into alternating current having a voltage equal to the customary household voltage supplied to the residences of a particular country or geographical region (e.g. 230V for European residences). The controller may include a display panel adapted to display one or more of the following: wind speed, wind direction, battery charge, cumulative energy generated to date, and voltage being generated by the wind turbine.

### BRIEF DESCRIPTION OF THE DRAWINGS

FIG. 1 is a front elevational view of an electrical generation system including a wind-turbine and a control system;

FIG. 2 is a side, elevational view of the wind-turbine of FIG. 1;

FIG. 3 is a front, elevational view of a residence and wind turbine showing an illustrative environment in which the electrical generation system may be used;

FIG. 4 is a diagram showing interconnections of various components of a control system for a wind turbine;

FIG. 5 is more detailed diagram of the control system of FIG. 4;

FIG. 6 is a detailed diagram of several internal components of a charge controller;

FIG. 7 is a diagram of one embodiment of an electrical generation system showing more components than the view of FIG. 1;

FIG. 8 is a diagram of the generator and generator control structures of the system of FIG. 7;

FIG. 9 is a diagram of the control system of the system of FIG. 7;

FIG. 10 is a chart showing various states that may be assumed by any of the electrical generation systems described herein;

FIG. 11A is a chart illustrating an arbitrary wind speed over a period of time;

FIG. 11B is a chart illustrating power that may be generated by an embodiment of the wind turbine system disclosed herein when experiencing the wind speeds shown in FIG. 11A; and

FIG. 11C is a chart illustrating pulsed power that may be generated by another embodiment of the wind turbine system disclosed herein when experiencing the wind speeds shown in FIG. 11B.

### DETAILED DESCRIPTION OF THE EMBODIMENTS

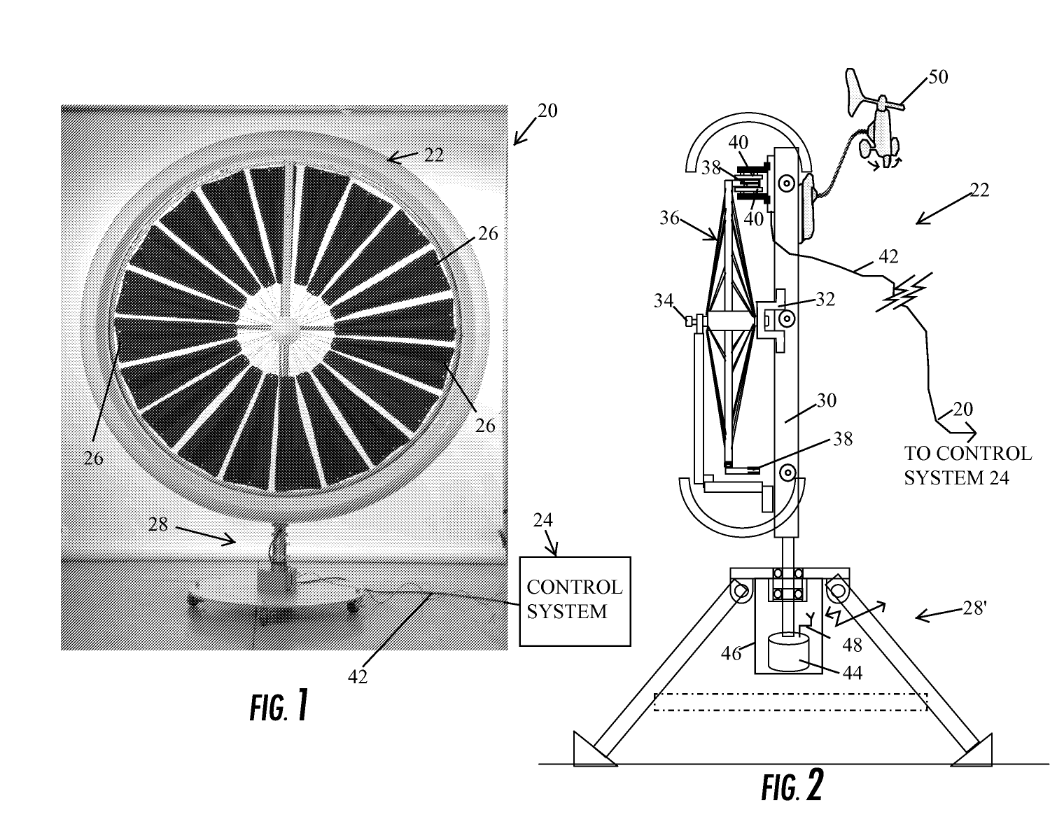

An electrical generation system 20 according to one embodiment of the present invention is depicted in FIG. 1. Electrical generation system 20, as depicted, includes a wind turbine 22 and a control system 24. Wind turbine 22, as will be discussed in greater detail below, is adapted to generate an electrical voltage in response to the wind causing a plurality of fan blades 26 on turbine 22 to rotate. Stated alternatively, wind turbine 22 generates electrical energy from the wind. Control system 24, as will also be discussed in greater detail below, is adapted to control the orientation of wind turbine 22 so that it faces the direction of the wind at a suitable angle for optimizing the electrical energy generated while also protecting wind turbine 22 from excessive wind speeds. Control system 24 is also adapted to process the generated electricity in a useful manner, such as by charging one or more batteries when sufficient electricity is being generated, or by transferring the electrical energy directly to a residential or commercial load when the load demand equals or exceeds the electrical energy currently being produced by turbine 22.

In the embodiments depicted in FIGS. 1-3, wind turbine 22 is constructed such that the fan blades 26 have a relatively high solidity. That is, the size and/or number of the blades 26 is such that the circular area defined by the rotation of the blades has a relatively small amount of area that is not occupied by the blades. Stated in yet another manner, there is a relatively small amount of space between the blades 26. In some embodiments, the amount of space between the blades may be less than 50% of the total area of the circle defined by the rotation of the blades 26. In other embodiments, the space may be less. In still other embodiments, the total area of the blades 26 may comprise 70% or more of the total area of the circle defined by the rotation of the blades 26.

The purpose of the relatively high solidity of blades 26 of wind turbine 22 is to allow wind turbine 22 to start rotating at relatively small wind speeds (i.e. to have a small cut-in wind speed), such as speeds of 1 or 2 miles an hour, although speeds even less than this may also be accommodated in certain configurations of turbine 22. It will be understood by those skilled in the art, however, that turbine 22 can be varied substantially from that depicted herein. For example, embodiments of electrical generation system 20 may be utilized with a wind turbine 22 that does not have a relatively high solidity. Further, electrical generation system 20 may comprise a wind turbine 22 that is substantially different in physical construction from wind turbine 22 pictured in FIGS. 1-3.

FIG. 2 depicts a side, elevational view of one manner in which wind turbine 22 may be constructed. Other constructions are, of course, possible. As shown in FIG. 2, wind turbine 22 includes a stand or mount 28 (FIG. 1) which supports wind turbine 22. Stand 28 may take on a variety of different configurations, such as that of stand 28′ shown in FIG. 2, as well as other variations. Supported on mount 28 or 28′ is a vertical shaft 30. A bearing bracket 32 is secured to shaft 30 by any suitable means. Bearing bracket 32 supports, either completely or partially, a horizontally oriented axle 34 about which fan blades 26 rotate. Fan blades 26, which are not shown in FIG. 2, are secured to a frame 36 that is rotatably mounted to axle 34. In one embodiment, frame 36 and axle 34 may comprise a conventional bicycle wheel to which fan blades 26 are suitably mounted. The use of a conventional bicycle wheel helps reduce manufacturing costs by incorporating pre-existing, mass-produced components. In other embodiments, frame 36 and axle 34 may be custom-manufactured, or constructed using other materials and/or components other than conventional bicycle wheels.

In the embodiment depicted in FIG. 2, a plurality of magnets 38 are mounted generally around a periphery of frame 36. Magnets 38 are positioned such that the magnetic flux of the magnets intersects with a plurality of stator coils 40 similarly positioned around the periphery of frame 36. As is well known from Faraday's law of induction, the movement of the magnetic flux from magnets 38 relative to the stationary stator coils 40 will induce a voltage inside of the stator coils 40. The stator coils 40 are physically arranged, and electrically coupled together, in such a manner that the voltages created inside each of them are added together, thereby causing an electrical current to flow in a wire or cable 42 that is fed into control system 24.

In other embodiments, the magnets 38 and stator coils 40 may be positioned inside of a gearbox located generally near the axle 34 about which blades 26 rotate. Such a gearbox may amplify the rotational speed of the magnets relative to the rotational speed of the blades 26 in a known manner to thereby increase the rate of change of magnetic flux intersecting stator coils 40, which, in turn, increases the voltage generated by wind turbine 22. Still other physical arrangements of the magnets 38 and stators are possible, including, but not limited to, such arrangements that are described in commonly owned, co-pending U.S. provisional patent application Ser. No. 61/179,968, filed on May 20, 2009 by applicant Imad Mahawili, Ph.D. and entitled WIND TURBINE, as well as the corresponding non-provisional application Ser. No. 12/714,913, filed on Mar. 1, 2010 by Imad Mahawili, Ph.D, entitled WIND TURBINE (Attorney Docket Number WIN04 P-104A), the complete disclosures of which are both hereby incorporated herein by reference. Control system 24 may be used in conjunction with the wind turbines described in this co-pending application, as well as other types of wind turbines having substantially different designs. Indeed, in some embodiments, control system 24 may be used with any type of wind turbine.

Wind turbine 22 further includes a motor 44 positioned adjacent a bottom end of vertical shaft 30 (FIG. 2). Motor 44 may be enclosed within a housing 46 adapted to shield motor 44 from the effects of the weather. Motor 44 is configured to interact with vertical shaft 30 such that operation of motor 44 will cause shaft 30 to rotate about its vertical axis. The rotation of vertical shaft 30 causes the orientation of wind turbine 22 to change. That is, the direction which wind turbine 22 faces may be altered by activating motor 44. Motor 44 may therefore be used to turn wind turbine 22 such that it faces into the wind, or is positioned at a particular angle with respect to the direction of the wind, as will be discussed in greater detail below.

The operation of motor 44 is controlled by control system 24. Control system 24 may transmit motor control commands to motor 44 by way of a wired connection (not shown) or a wireless connection. When using a wireless connection, motor 44 may include an antenna 48 (FIG. 2) that receives the commands from control system 24 and implements them accordingly. Such wireless transmission of commands to motor 44, as well as the transmission of status information from motor 44 to control system 24, may be carried out using any suitable transmission protocol or standard, such as, but not limited to, Bluetooth (IEEE 802.15.1 standards), WiFi (IEEE 802.11 standards), and other wireless technologies. In addition to receiving commands from control system 24, motor 44 may also transmit status information to control system 24, such as the angular orientation of wind turbine 22 (e.g. whether facing north, south, east, west, etc), as well as other information.

In at least one embodiment, turbine 22 includes suitable rectifiers that convert the AC voltage generated at the turbine 22 to DC voltage prior to transmitting the voltage to control system 24. In other embodiments, the AC voltage could be rectified by control system 24, or used without rectification.

An anemometer 50 may be positioned adjacent wind turbine 22 (FIG. 2) in order to measure wind speed and/or wind direction. When utilized, anemometer 50 is configured to generate electronic readings of the wind speed and/or wind direction and to forward those readings to control system 24 in any suitable manner. The transmission of these readings to control system 24 may be done wirelessly via a separate transmitter attached to, or electrically coupled to, anemometer 50. Alternatively, anemometer 50 may feed its readings to the transmitter utilized by motor 44. In other embodiments, a wired connection may be used to send anemometer 50's readings to control system 24. Such wired connections may utilize a separate wire between anemometer 50 and control system 24, or they may be transmitted via power line 42 through any suitable coding technique that allows control system 24 to separate the anemometer's readings from the electrical power generated by wind turbine 22 that is transmitted to control system 24 over wire 42.

In still other embodiments, the wind speed may be measured by suitable sensors attached directly to wind turbine 22, rather than through the use of a separate anemometer. Or, in still other embodiments, the wind speed may be determined by measuring the amount of electrical current transmitted through line 42 in combination with a known wind speed profile of wind turbine 22 that identifies the amount of power generated by turbine 22 over a range of speeds. Such a profile may be stored in a memory of control system 24.

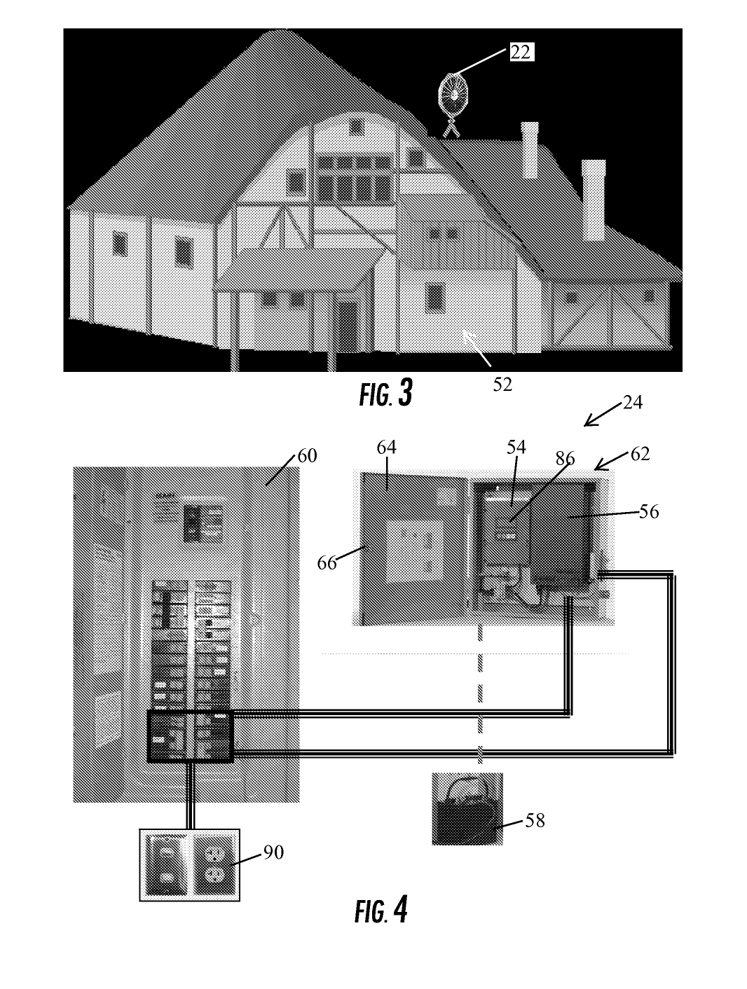

Electrical generation system 20 may be used to either supply the entire electrical needs of a residence, such as a residence 52 (FIG. 3), or it may be used to supplement the electrical power supplied to a residence 52 from a utility company. As will be described in more detail below, generation system 20 may be easily configured to supply electrical energy to one or more circuits within a residence by integrating the system 20 into the pre-exiting breaker box or distribution panel within the residence. Alternatively, electrical generation system 20 may be used to supply electrical power to businesses, or any other consumers of electrical power. Multiple electrical generation system 20 may also be combined together to increase the supply of electrical energy. Wind turbine generation system 20, in some embodiments, has a physical footprint enabling it to be mounted onto a residence 52 (FIG. 3), or to be conveniently positioned within a residential yard without occupying an undue amount of space.

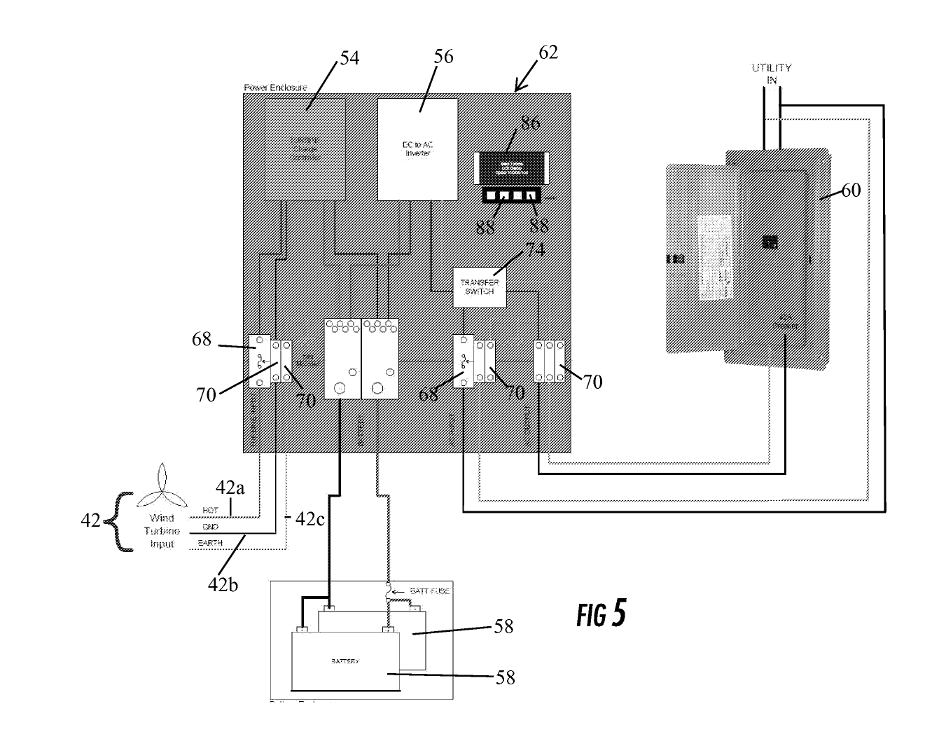

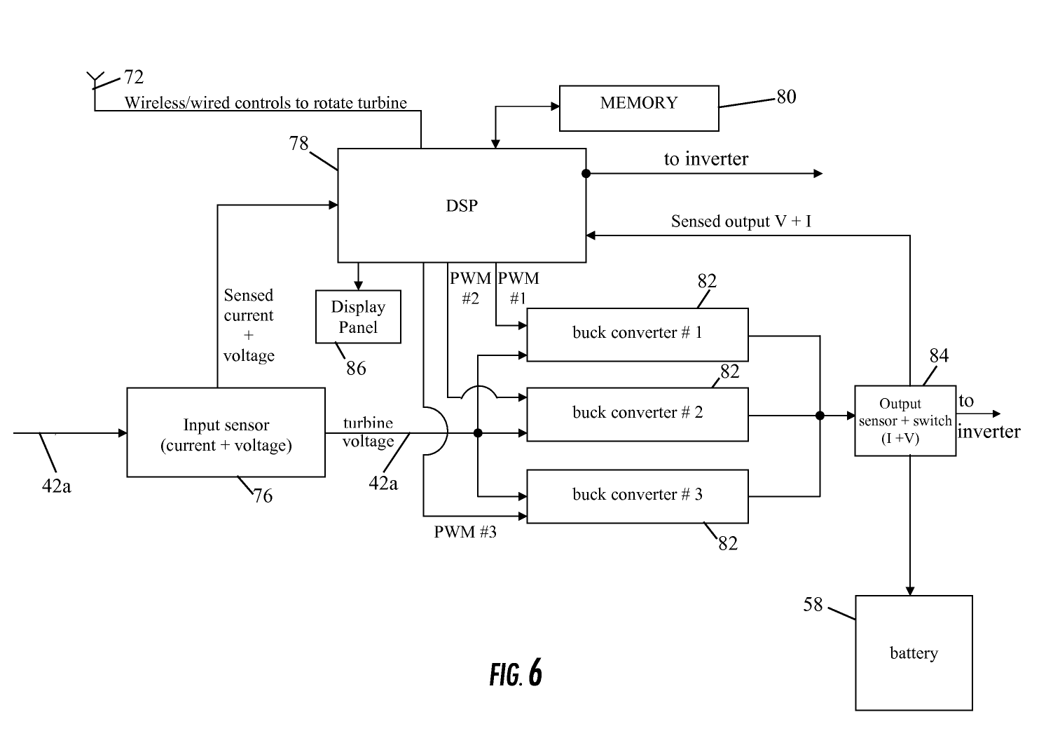

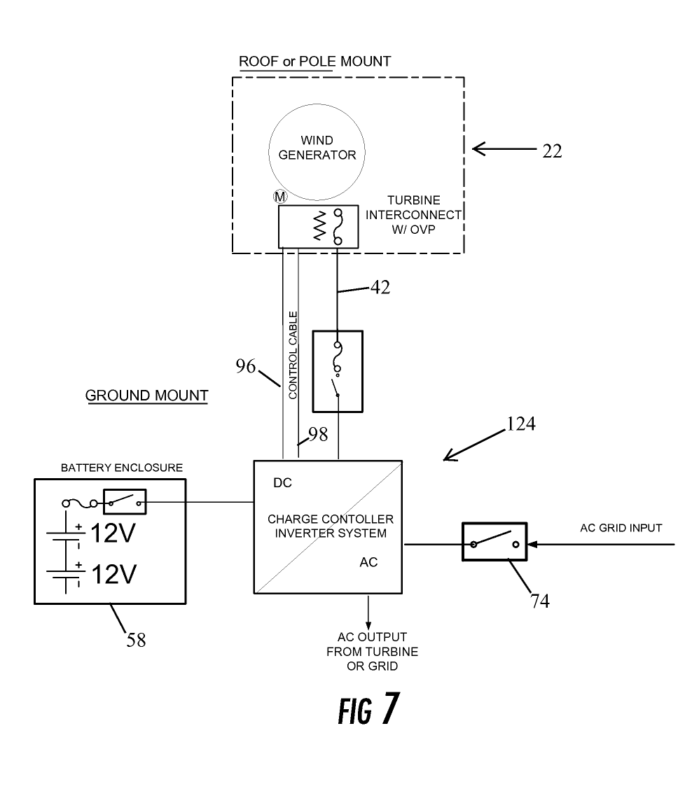

A generalized schematic diagram of one embodiment of control system 24 is illustrated in FIG. 4. A more detailed diagram of the embodiment shown in FIG. 4 is illustrated in FIG. 5. FIG. 6 shows a more detailed diagram of one embodiment of a charge controller 54 that may be used with control system 24. It will be understood by those skilled in the art that the details of control system 24 may be varied substantially from the embodiments depicted herein.

Control system 24, in the embodiment shown in FIGS. 4 and 5, includes charge controller 54, an inverter 56, one or more batteries 58, and suitable electrical wires/cables for connecting control system 24 to wind turbine 22 and one or more distribution panels 60. The one or more distribution panels 60 may be conventional distribution panels 60 found within a home or residence and used to distribute the utility-supplied electrical power amongst the various circuits that supply electricity throughout the residence or business. Such distribution panels typically include fuses or circuit breakers for each of the electrical circuits within the residence or business that supply electricity to electrical outlets 90 positioned in different areas of the residence or business. Control system 24 can be easily coupled to such a distribution panel to enable one or more of the circuits of the distribution panel to receive its electricity from electrical generation system 20. Thus, for example, if the home or business includes a separate circuit for a hot tub, or a water heater, or a particular room or area of the home or business, electrical generation system 20 can be coupled to the distribution panel 60 such that the electricity for the water heater, or room, or area, can be supplied by system 20, rather than the utility company. Of course, as will be explained in greater detail below, electrical system 20 is constructed, in at least one embodiment, such that, in the absence of sufficient wind power and/or the drainage of batteries 58, system 20 will automatically switch to supplying the desired electrical power from the utility company. In this manner, electricity is supplied to the connected circuits even in no-wind conditions and when battery 58 is drained.

Electrical generation system 20 is also configured such that, upon an interruption in utility-supplied electrical energy to the home or business, system 20 will automatically switch to a back-up mode in which it will supply electrical energy to the home or business via one or more batteries 58 (in no-wind or insufficient-wind situations) or via wind turbine 22. In this manner, system 20 acts as a sort of emergency generator that automatically kicks in when an interruption in utility-supplied power is detected, thereby providing continuous electrical service to the home or residence and thereby also eliminating the requirement of a person manually starting or otherwise manually activating a gasoline, or other fuel-powered, emergency generator. After such an interruption in utility-supplied electrical power, system 20 will continue to supply electricity to the home or business for as long as it is able until the utility-supplied electricity returns. Once the utility-generated power returns, system 20 will-recharge the battery or batteries 58, either through power generated from turbine 22 or through utility-supplied power, or a combination of both.

As illustrated in FIGS. 4 and 5, turbine charge controller 54 and inverter 56 may be housed within an enclosure 62 that may be mounted to a wall, or other suitable structure, within the home or other facility receiving electrical power from turbine 22. Enclosure 62 may include a door 64 that opens and closes to allow access to the interior of enclosure 62 where charge controller 54 and inverter 56 are located. Door 64 may include a lock 66 to prevent unauthorized access to enclosure 62.

As shown in FIG. 5, cable 42 may comprise a plurality of individual wires, such as a positive or “hot” wire 42a, a ground wire 42b, and an earth wire 42c. Hot wire 42a carries the direct current generated by wind turbine 22 to control system 24. Hot wire 42a feeds into enclosure 62 and passes through a fuse 68 prior to being fed into charge controller 54. Ground and earth wires 42b and 42c are attached to suitable connectors 70 inside, or adjacent, enclosure 62. As will be discussed in more detail below, charge controller 54 monitors the voltage and current of hot wire 42a and makes various adjustments and control decisions based upon these voltage and current levels, as well as based upon other conditions, such as the state of charge of batteries 58 and/or the load electrically coupled to control system 24.

Charge controller 54 is also in communication with motor 44 and anemometer 50. Such communication may occur by any of the methods discussed previously. As shown in FIG. 5, charge controller 54 is in communication with an antenna 72 that detects the wireless signals transmitted by motor 44 (through antenna 48) and/or anemometer 50, which may transmit wireless signals through the same antenna 48 or some other antenna. Alternatively, charge controller 54 may receive the wind speed and wind direction information from anemometer 50 and the orientation information from motor 44 through other communication channels. Charge controller 54 uses the wind speed and wind direction signals, in combination with the measurements of voltage and current in hot wire 42a, to control the charging of batteries 58, the movement of motor 44, the state of a transfer switch 74, the operation of one or more DC-DC converters internal to controller 54 (such as buck converters, or other suitable converters, as discussed more below), and the operation of inverter 56.

In general, charge controller 54 converts the voltage of the incoming DC electrical current from wind turbine 22 (received via hot wire 42a) to a more suitable voltage level that may be applied to either or both of inverter 56 and/or battery 58. Inverter 56, in turn, converts the DC current it receives from either battery 58 and/or inverter 56, or both, into an AC current having a voltage level and frequency suitable for use in the home or business to which system 20 is supplying power. Thus, for North American homes or businesses, inverter 56 outputs a 120 volt, 60 Hertz (Hz) alternating current signal. For European homes or businesses, inverter 56 may be configured to output 230 volts AC at a frequency of approximately 50 Hz. To the extent inverter 56 supplies electricity to other loads, such as directly to a utility company for the re-sale of electricity thereto, the voltage level and frequency may be adjusted to whatever is suitable for the intended load.

A more detailed schematic of one embodiment of charge controller 54 is illustrated in FIG. 6. It will be understood by those skilled in the art that the construction and design of charge controller 54 may vary substantially from that shown in FIG. 6. In the embodiment of FIG. 6, charge controller 54 includes an input sensor 76, a digital signal processor (DSP) 78, a memory 80, a plurality of buck converters 82, and an output sensor 84. Input sensor 76 is coupled to hot wire 42a and senses the voltage level and current levels in hot wire 42a. The particular construction of input sensor 76 may take on any suitable form, and may involve an analog-to-digital converter (not shown) that outputs a digital signal to DSP 78 indicating the voltage and current levels of hot wire 42a. After passing through input sensor 76, hot wire 42a is fed into a plurality of parallel arranged buck converters 82 that reduce the DC voltage of hot wire 42a to a more suitable level. The outputs of the buck converters 82 are combined together and fed into output sensor 84, which senses the current and voltage of the combined outputs of the buck converters 82. The sensed current and voltage levels are fed back to DSP 78. The outputs from the buck converters 82 are then either coupled to battery 58 or to inverter 56, or to both, depending upon the amount of electricity currently being generated by wind turbine 22 and the electrical needs of inverter 56 and battery 58.

While other designs may be utilized, the buck converter 82 of the embodiment shown in FIG. 6 operate at a 30 KHz switching frequency. The switched output is fed into a torroid inductor (not shown) that smoothes the switched DC into a controlled DC output, which is then fed into output sensor 84. The output voltage level of the buck converters 82 are each controlled by pulse width modulated (PWM) signals sent by DSP 78 along PWM lines #1, #2, and #3. By sending the appropriate pulse width along these lines, DSP 78 is able to change the voltage level of hot wire 42a to a suitably regulated voltage level that may be fed into batteries 58 and/or inverter 56.

DSP 78 may take on any suitable form. In one embodiment, DSP 78 may be a digital signal processor manufactured by Texas Instruments under the part number TMS320F2802. Of course, other types of DSPs may be used. DSP 78 provides monitoring of all currents and voltages, and provides the DC switching control for buck converters 82. DSP 78 also receives inputs from anemometer 50 and motor 44, which include wind speed, wind direction, and the direction wind turbine 22 is currently facing.

The voltage generated by wind turbine 22 and supplied to hot wire 42a may, in some embodiments, range as high as 350 volts. In other embodiments, higher voltages may be generated and processed by control system 24. DSP 78 uses the sensed voltage and current from input sensor 76 to compute the power and impedance at any given time from wind turbine 22. Using a known, pre-calculated impedance for maximum power, calculated from tested power curves for wind turbine 22, DSP 78 matches the impedance in real time to provide maximum power to the load that is available from turbine 22 at any given time. DSP 78 is thus configured to achieve a maximum power point at any wind speed by matching the source impedance to the load impedance.

As noted above, hot wire 42a is fed into three parallel buck converters 82. The buck converters may contain a MOSFET, a MOSFET driver, and an inductor. Based on the available power determined from the calculated input impedance along with what is compared to the known available power, DSP 78 will adjust the on and off time of the MOSFETs via the PWM signals sent along PWM lines #1, #2, and #3. By increasing the on time (i.e. the duty cycle of the PWM signals), more power will be delivered to the load. Conversely, by reducing the on time, less power will be delivered to the load. Further, the PWM signals determine the impedance of the control system, and, as a result, the PWM signals can be adjusted such that the turbine impedance matches the control system's impedance for maximum power delivery.

Different numbers of buck converters may be used other than the three illustrated in FIG. 6, such as, but not limited to, four buck converters 82, five, or other numbers. Further, in some embodiments, more than one buck converter 82 may be on at the same time. For example, if four buck converters 82 are utilized, they may be used in a 180 degrees phase shifted manner whereby two buck converters 82 are on and the other two buck converters 82 are off. This distributes the heat generated within the buck converters across multiple converters, thereby allowing lower cost buck converters to be used.

The buck converters 82 may be arranged in parallel and utilized individually at a suitable frequency, such as, but not limited to, 30 KHz, wherein their individual usage is synchronized with each other and phase shifted by 120 degrees. This phase shifting allows only one of the buck converters to be on at any one time. This causes the wind turbine to see a switch frequency that is three time the frequency of the individual buck converters 82 (such as 90 KHz) when three buck converters 82 are used, and allows the heat generated by each buck converter 82 to be spread out amongst the multiple buck converters, thereby allowing lower cost MOSFETs to be used. The voltage output from the MOSFETs is fed inside the buck converter to an inductor and capacitor (not shown) that smooth out the DC switching ripples. The result is a controlled DC output from the buck converters 82 that has a voltage proportional to the on time of the switching MOSFETs.

Output sensor 84 senses the voltage and current of the combined outputs of the buck converters 82 and passes this information to DSP 78. DSP 78 uses this information to calculate the output voltage and the current being provided to battery 58 for charging, or being supplied to inverter 56, or both. If battery 58 is in need of charging (as determined by any suitable connections and/or monitoring circuitry between battery 58 and DSP 78), DSP 78 will, in at least one embodiment, use a multistage charging algorithm to charge battery 58 or batteries 58. In a first stage, DSP 78 provides a bulk charge that replaces approximately 70-80% of the batteries' state of charge at a fast rate. This bulk charge stage uses a constant current algorithm that supplies a constant current to the batteries.

Following the constant current re-charging stage, DSP 78 may implement an absorption stage. The absorption stage replenishes the remaining 20-30% of the charge by bringing the batteries to a full charge at a relatively slow rate. The absorption charge stage supplies a constant voltage algorithm that maintains a constant voltage to the batteries. After the absorption stage, a float stage may be provided by DSP 78. The float stage reduces the voltage and holds it constant in order to prevent damage to the batteries and to keep the batteries at full charge.

While other types of batteries may be used, battery 58 may be, in one embodiment, a conventional automobile battery. Further, as has been noted, multiple batteries 58 may be ganged together to provide a greater reserve of electrical energy for supply to distribution panel 60 when the wind conditions are not sufficient to allow wind turbine 22 to supply all of distribution panel 60's current electrical needs. Other types of batteries, such as those that supply less instantaneous power but greater long-term power, may also be used. Indeed, in some embodiments, it may be desirable to avoid using automotive batteries because such batteries are designed for short term supply of large currents where the battery is not deep cycled. For use in electrical generation system 20, or 120 (as discussed more below), it may be beneficial to use batteries that are specifically designed to be deep cycled often, such as, but not limited to, batteries that are capable of being discharged down to at least 80% of their charge time after time. Such batteries typically have solid lead plates, rather than sponge lead plates. Such batteries will allow greater ease in time-shifting the electricity usage of generation system 20 and 120 wherein the time between the generation of the electricity (i.e. when the wind is blowing) and the time when the electricity is used, may be greater. Further, such batteries will allow more power to be supplied to the home or business in the absence of wind. Other advantages of deep cycle batteries may also arise.

In some embodiments, DSP 78 is programmed to prevent battery 58 from experiencing a deep cycle discharge except when DSP 78 senses an interruption in utility supplied power. This feature is implemented when the particular type of battery being used will have its life shortened by deep cycling. When DSP 78 senses an interrupt in the utility supplied power, which may be accomplished by any suitable connection to distribution panel 60 (not shown), or other known means, DSP 78 is programmed to automatically couple battery 58 to distribution panel 60 and allow battery 58 to discharge for as long as the utility-power remains cut off. This feature allows uninterrupted power to be delivered to the electrical products that receive their electrical power from the particular circuit, or circuits, of distribution panel 60 that are integrated with electrical generation system 20.

Further, DSP 78 may be programmed to selectively apply the power from battery 58 to particular circuits of distribution panel 60 upon the failure of utility-supplied power. For example, DSP 78 may be programmed to couple battery 58 to those circuits deemed most critical to maintain during a power outage. Such circuits may, for example, include the circuits that supply electricity to the home or business's sump pump, the furnace, or the like. When DSP 78 senses that utility-supplied power has returned, it commences re-charging the one or more batteries 58. In one embodiment, if no wind is available at that particular time, DSP 78 sends out a command to transfer switch 74 (FIG. 5) commanding it to switch in a manner that couples suitable utility-supplied electrical power to battery 58 to recharge it. In another embodiment, if no wind is available at that particular time, DSP 78 waits to recharge the one or more batteries 58 until sufficient wind returns. In either embodiment, if there is insufficient wind currently available and battery 58 is insufficiently charged to adequately supply distribution panel 60, DSP 78 couples the utility-supplied power back to all of the circuits of distribution panel 60 such that power to the electrical products in the home or business is not interrupted. This utility-supplied power will continue to be supplied until sufficient wind power returns to once again switch off the utility-supplied power.

DSP 78 may receive its power from one or more of batteries 58, or it may receive its power from a utility-supplied source, or it may receive its power from wind turbine 22, or any combination of these three sources. Whatever the source, DSP 78 is configured such that it will still receive sufficient electrical power to carry out its control operations even during power outages of the utility-supplied electrical power. Indeed, in some embodiments, DSP 78 may be supplied by one or more batteries separate from batteries 58 that exclusively supply power to charge controller 54 and/or the other electrical components housed within enclosure 62.

In order to prevent damage to wind turbine 22, DSP 78 communicates with motor 44 and sends motor commands based upon the wind speed and direction sensed by anemometer 50. DSP 78 repeatedly determines whether the wind is excessive for wind turbine 22 by comparing the measured wind speed to a threshold stored in memory 80 of controller 54. The threshold is based upon the particular wind turbine 22 that is being used, and may vary between different models of wind turbines 22. The threshold wind speed stored in memory 80 represents a speed above which damage may occur to wind turbine 22. DSP compares the measured wind speed from anemometer 50 to the threshold wind speed and, if the measured wind speed exceeds the threshold speed, DSP 78 sends a command to motor 44 to rotate wind turbine 22 such that it no longer faces directly into the wind. By turning wind turbine 22 out of direct alignment with the wind during high-wind conditions, the likelihood of damage to wind turbine 22 is reduced.

DSP 78 further rotates wind turbine 22, via motor 44, depending upon the amount by which the currently measured wind speed exceeds the threshold wind speed stored in memory 80. The greater the amount by which the currently measured wind speed exceeds the threshold wind speed, the greater the amount of misalignment of wind turbine 22 with respect to the wind direction DSP 78 commands. That is, the higher the wind speed above the threshold, the higher the rotation of wind turbine 22 out of direct alignment with the wind direction. By rotating wind turbine 22 more and more out of alignment with the wind during ever increasing wind speeds, the wind pressure applied to blades 26 is reduced, and the likelihood for damage to wind turbine 22 is also reduced.

When DSP 78 senses that the current wind speed has decreased, it sends suitable commands to motor 44 causing wind turbine 22 to rotate back toward the current wind direction. If the current wind speed drops to the threshold wind speed, or below, DSP 78 sends commands to motor 44 to rotate wind turbine 22 such that it is directly aligned with the current wind direction. DSP 78 and motor 44 thus work in cooperation to ensure that the wind turbine 22 is always facing directly into the wind whenever the wind speed is below the threshold wind speed, and is facing out of alignment with the wind by an amount that is related to the amount by which the threshold speed is exceeded.

Depending upon the voltage in hot wire 42a, processor 78 may couple hot wire 42a directly to inverter 56, rather than to battery 58, when sufficient power is being generated by wind turbine 22 to supply the one or more circuits of distribution panel 60 that are electrically coupled to power generation system 20. Such direct coupling improves the efficiency of system 20.

Charge controller 54 may be coupled to a display panel 86, which may be a liquid crystal display (LCD), or other type of display panel (FIGS. 5-6). DSP 78 is configured to allow a variety of different types of information to be selectively displayed on display panel 86. One or more buttons 88, or other types of user interface devices, may also be coupled to DSP 78 so as to enable a person to control what information is displayed on display panel 86. DSP 78, in one embodiment, is configured to allow the following information to be displayed on display panel 86: power currently being generated, current wind speed, current wind direction, current open voltage, current load voltage, current battery voltage, cumulative energy generated to date, time, date, year, charging status, and any faults.

Electrical generation system 20 may be configured to sink any excess electricity it generates into a dummy resistive load (not shown), or it may supply such excess power to a water heater, or it may supply it back to the utility. That is, when all of batteries 58 are fully charged and wind turbine 22 is supplying more electricity than is currently being demanded by the associated loads on distribution panel 60, system 20 may transfer the excess electricity being generated to any of these, or other, destinations. DSP 78 may further be configured to keep track of how often such periods of excessive electricity generation occur, and/or the amount of excessive power that is generated. This information may be displayed on panel 86 and provide an indication to a user of system 20 as to how frequently system 20 is generating more electricity than is being consumed. If this occurs frequently, the user may wish to add further batteries 58 and/or to couple system 20 to a greater number of circuits within panel 60, or to couple system 20 to different circuits within distribution panel 60 that have larger or more frequent loads.

FIGS. 7-9 illustrate in more detail an embodiment of electrical generation system 120. The embodiment shown in FIGS. 7-9 includes multiple components in common with electrical generation system 20, and those common components bear the same label as they do in system 20 and operate in the same manner as they do in system 20, unless otherwise noted. Such common components therefore do not need to be described in greater detail.

As shown in FIG. 7, electrical generation system 120 includes wind turbine 22 and a control system 124. Cable 42 connects wind turbine 22 to control system 124. A control cable 96 and a motor rotation cable 98 also pass between wind turbine 22 and control system 124. Cables 96 and 98 may be bundled together with cable 42, or they may be separately bundled. Cables 42, 96, and 98 are of a sufficient length such that control system 124 may be physically positioned remotely from wind turbine 22 at a location that is more convenient for storing control system 124. As but one example, cables 42, 96, and 98 may be sufficiently long to allow control system 124 to be positioned inside of a home, building, garage or other enclosure protected from the elements.

Electrical generation system 120 further includes one or more batteries 58 for storing unconsumed electricity generated by wind turbine 22. As with system 20, controller 124 of system 120 charges batteries 58 when electricity is currently being generated by turbine 22 that exceeds the electrical demands being placed upon system 120. Similarly, controller 124 of system 120 utilized batteries 58 to meet electrical demands that exceed the contemporaneous electricity generating capability of turbine 22. Controller 124 thus utilizes one or more batteries 58 for storing excess electricity for supply at later times, if needed.

As is further shown in FIG. 7, electrical generation system 120 includes AC transfer switch 74 that allows the system to be selectively coupled to, and decoupled from, the AC power supplied by an electrical utility. Such coupling is desirable when insufficient wind is currently available for conversion to electricity and the charge level of the batteries 58 is likewise insufficient to meet the current electrical demand. Such decoupling is desirable when the batteries 58 and/or wind turbine 22 are able to provide sufficient electricity to meet the current electrical demands placed upon the system 120.

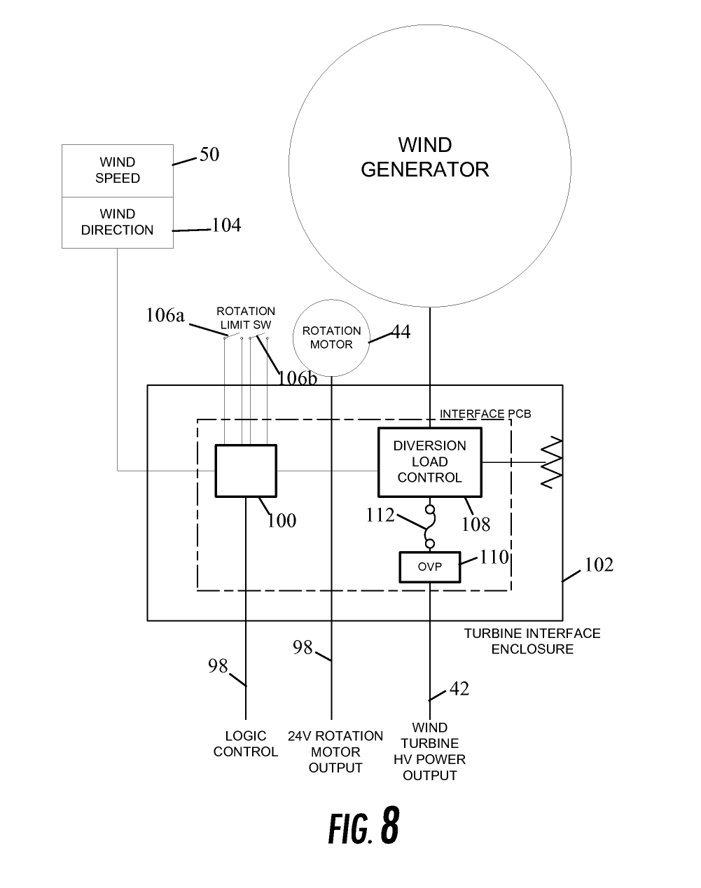

As is illustrated in greater detail in FIG. 8, control cable 96 is operatively coupled to a control circuit 100 that may be housed within a turbine interface enclosure 102. Control circuit 100, in turn, receives inputs from both a wind speed sensor, such as an anemometer 50, and a wind direction sensor 104. Control circuit 100 further receives inputs from first and second limit switches 106a and 106b. Limit switches 106a and 106b detect when turbine 22 has rotated to its extreme limits about shaft 30. In one embodiment, turbine 22 may be configured such that it is able to rotate approximately 340 degrees about the vertical axis defined by shaft 30. Other ranges of rotation may also be implemented, including configurations in which turbine 22 is free to rotate a full 360 degrees about shaft 30. When control circuit 100 receives a signal from either of limit switches 106a or 106b, it sends a signal along logic control cable 96 to control system 124. Control system 124 may then terminate power to rotation motor 44 by ceasing to supply an electrical current to motor 44 via motor rotation cable 98. Alternatively, or in addition, control circuit 100 may directly disable any power supplied to rotation motor 44 by cable 98 through appropriate switching. However implemented, limit switches 106 serve to prevent motor 44 from attempting to rotate turbine 22 past its prescribed range of rotational motion. Any such disabling of power to rotation motor 44 is limited to only disabling power that would cause turbine 22 to move further in the direction that caused the limit switch to be activated. That is, rotation motor 44 is prevented from moving past the outer boundaries of its limited range of motion, but is still free to rotate within those boundaries.

Turbine interface enclosure 102 may further include a diversion load control 108, which acts to sink excessive current generated by wind turbine 22 when the wind speed is high enough to generate more electricity than can be safely processed by control system 124. In at least one embodiment, control system 124 may be configured to be able to process 170 volts DC from wind turbine 22. Other embodiments may vary this number, either higher or lower. In at least one embodiment, diversion load control 108 will engage a diversion load if the turbine is currently generating 170 volts or more. Such engagement may happen without any input or signals from control system 124. In other words, diversion load control 108 may act autonomously to engage the diversion load.

Diversion load control 108 may also include a maximum overvoltage protection circuit 110 that prevents a maximum output voltage from being exceeded by wind turbine 22. As one example, such maximum overvoltage might be set at 250 volts. Other values can, of course, be used. If the diversion load of diversion load control 108 fails to limit the voltage, and the voltage output from turbine 22 tries to increase above 250 volts (where 250 volts is the illustrative maximum), circuit 110 will clamp the voltage and blow a fuse 112. This will prevent an overvoltage condition that could create a fire risk to components that have rated maximums of 250V downstream of the turbine interface enclosure 102. In such a situation, the turbine will let loose and will spin at an uncontrolled speed.

Turbine interface enclosure 102 is connected to control system 124 via cables 42, 96, and 98, as was noted previously. Cable 42 supplies the DC voltage generated by turbine 22 to control system 124. Control cable 96 supplies signals to controls system 124 indicating the direction of the wind, the speed of the wind, and, in at least some embodiments, the current position of the rotation motor 44. Cable 98 supplies power to rotation motor 44, causing it to turn in a manner controlled by control system 124, and as has been described previously. That is to say that control system 124 controls rotation motor 44 such that, in excessive wind conditions, turbine 22 is turned out of the wind a sufficient amount to prevent more than the rated amount voltage from being generated, and in less-than excessive wind conditions, turbine 22 is turned into the wind.

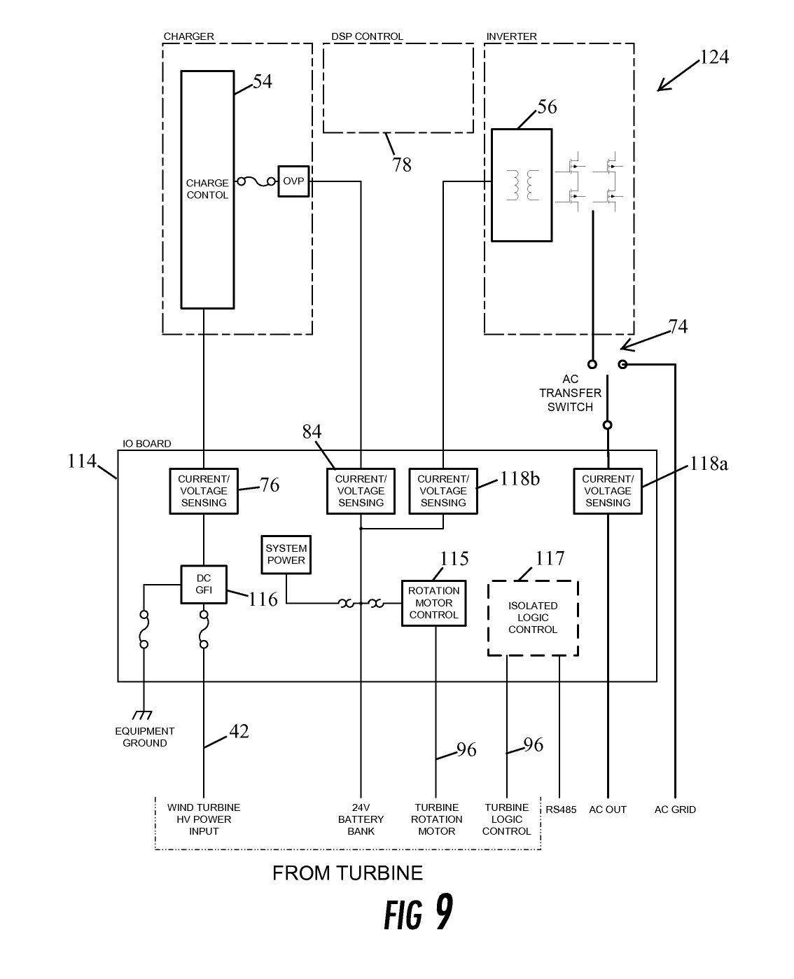

FIG. 9 illustrates an embodiment of control system 124 in greater detail. The components of control system 124 that are common to control system 24 are labeled with the same number and operate in the same manner as previously described, unless indicated to the contrary. Control system 124 includes an I/O board 114 which includes various electrical components for interfacing with turbine interface enclosure 102, as well as charge controller 54 and inverter 56. Cables 42, 96, and 98 feed into I/O board 114. More specifically, cable 42 feeds into a DC ground fault interrupter 116, before passing onto a current/voltage sensor 76. A suitable fuse may be positioned between cable 42 and GFI 116. Current/voltage sensor 76 operates in the same manner as previously described and senses the current and voltage currently being generated by wind turbine 22. This information is passed onto charge controller 54, including its digital signal processor 78, which uses the information to process the voltage generated by turbine 22 in the manner previously described.

Control system 124 further includes a rotation motor control circuit 115 that outputs control signals causing rotation motor 44 to rotate in the desired manner. Rotation motor control circuit 115 receives control inputs from isolated logic control 117. Isolated logic control 117, in turn, receives signals from logic control cable 96. These signals, as noted previously, indicate the current wind speed and direction, as well as which limit switch 106, if any, has been activated. Logic control cable 96 may further transmit information indicating the current rotational orientation of motor 44 to isolated logic control circuit 117. Isolated logic control circuit 117 uses the information it receives from control cable 96 to determine what changes, if any, should be made to the orientation of wind turbine 22. Such changes, if any, are communicated to rotation motor control 115, which then sends appropriate signals on cable 98 to rotation motor 44 that cause rotation motor 44 to turn in the desired manner.

Control system 124 further includes output sensor 84, which measures the voltage and current being output by charge controller 54. Control system 124 also includes a pair of additional current/voltage sensors 118a and 118b that measure the current and voltage passing through two other locations of control system 124. Sensor 118a measures the voltage and current being output by control system 124. That is, sensor 118a measure how much current and voltage is being supplied by electrical generation system 120 for usage within a house, building, or other facility. Sensor 118b measures the voltage and current being supplied to inverter 56. DSP processor 78 uses the information from sensors 118a and 118b in controlling the charging/discharging of the bank of batteries 58, as well as in controlling A/C transfer switch 74. As was noted, A/C transfer switch 74 switches between having turbine 22 provide power and the electrical utility (AC grid) provide power to the house, building, facility, or particular circuit(s) within one of these units.

System 124 monitors the output of sensor 118a to determine whether to switch to the AC grid or not. In at least one embodiment, system 124 is configured to switch to the AC grid whenever the total load being placed upon the electrical generation system 120 exceeds system 120's current electrical production capabilities, taking into account both the electrical production from turbine 22 as well as the electrical production from batteries 58. Thus, for example, suppose that a 1000 watt load is being applied to system 120. Suppose further that system 120 was configured such that it supplied 24 volts to inverter 56, whether from batteries 58 or charge controller 54. Still further, suppose that the wind was currently blowing at a speed that enables 15 amperes of current to be generated from wind turbine 22. Another 26.6 amperes of current would then have to be drawn from the battery to meet the 1000 watt demand. Batteries 58 would then slowly discharge as they continued to supply these 26.6 amperes. Once the batteries were discharged, system 124 would switch back to the AC grid, via switch 74, and turn inverter 56 off. Further, system 124 would start charging the batteries using the fifteen amperes of current available from wind turbine 22. While the batteries were recharging, the AC grid would supply all of the 1000 watts to the load. Only after the batteries 58 were fully recharged, or charged to within a threshold of their full charge—which could be a variable threshold and which could be programmable—would system 124 switch off of the AC grid and back to receiving power from wind turbine 22 and the batteries. In this manner, system 124 either uses or stores the wind energy whenever it is available, unless the batteries are all charged and no electrical demands are present.

FIG. 10 shows a chart of the various states that may be assumed by either of electrical generation systems 20 or 120. Such states are, of course, only one possible configuration that may be applied to systems 20 and 120, and it will be understood that either or both of system 20 and 120 can be configured in manner different from that shown in FIG. 10. The current state of system 20 or 120, as shown in FIG. 10, may be viewable on an LCD screen of display pad 86. The left-most column in FIG. 10 indicates the state of system 20 or 120. The next column provides a description. The “charger” column indicates whether the charge controller 54 is on, waiting, or in some other condition. The “inverter” column indicates the state of the inverter 56. The “TS” column indicates the state of the transfer switch 74. The “dump” column indicates whether electricity is being routed to the diversion load by diversion load control 108 or not. FIG. 10 thus provides one example of the manner in which system 20 or 120 may be controlled via control system 24 or 124. Other manners may also, of course, be used.

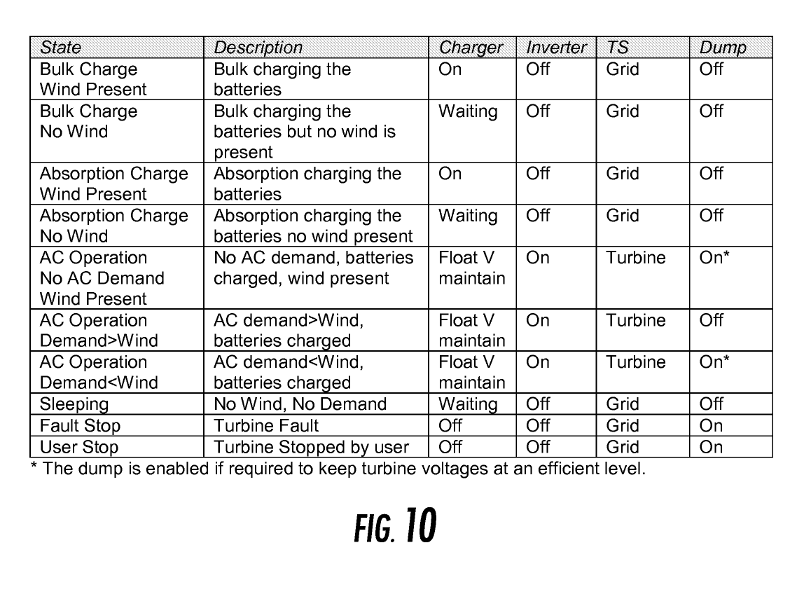

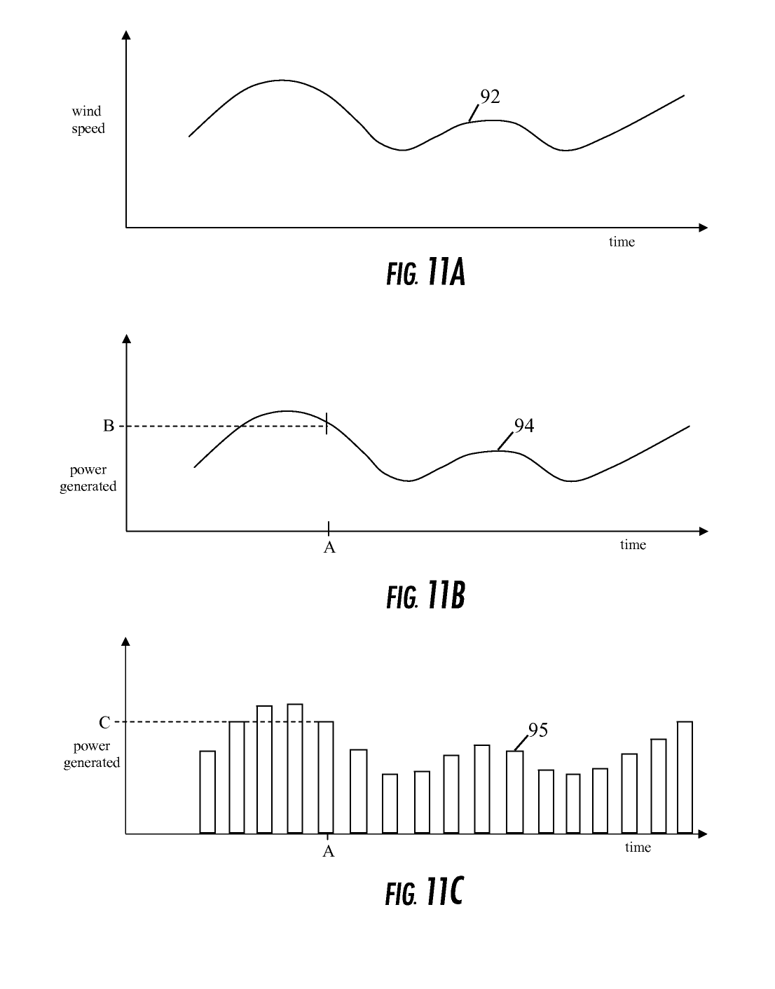

As has been described above, DSP 78 of electrical generation systems 20 and 120 may beg programmed such that the PWM signals sent to the buck converters 82 are adjusted so that the source impedance (turbine 22) matches the load (control system 24) impedance. Such embodiments tend to produce power that follows the wind speed. An example of this is seen in FIGS. 11A and 11B. FIG. 11A illustrates an arbitrary wind speed with respect to time wherein the wind speed is represented by the curve 92. When DSP 78 is programmed to continually adjust its load impedance so that it matches the turbine impedance, the power output will generally follow the wind speed, as illustrated in FIG. 11B by the power curve 94, where the shape of the power curve generally matches the shape of the wind speed curve 92 of FIG. 11A. Such continuous impedance matching, however, can be modified in some embodiments of electrical generation system 20 and 120.

For example, either of electrical generation systems 20 and 120 may be modified to create power pulses generally like the pulses 95 illustrated in FIG. 11C (when subjected to wind speeds like that shown in FIG. 11A). In the embodiment represented by FIG. 11C, DSP 78 controls buck converters 82 to generate input impedances that alternate between being higher and lower than the impedance of turbine 22. This creates the power peaks shown in FIG. 11C. Such power peaks will transiently exceed the power generated by the system shown in FIG. 11B. In other words, for example, the power represented by reference letter B in FIG. 11B is lower than the peak power represented by the reference letter C in FIG. 11C, despite the fact that both powers are generated at the same moment in time (identified by the reference letter “A”) under the same wind conditions. Because of the higher peaks of the system of FIG. 11C relative to the system of FIG. 11B, the system of FIG. 11C may be more effective at charging the batteries 58 than the system of FIG. 11B, particularly at low wind speeds. What qualifies as a low wind speed will naturally vary from turbine to turbine, but in at least one embodiment, such low wind speeds may refer to any wind speeds below seven miles per hour. In other embodiments, a lower or a higher speed might be considered “low speed,” depending, as noted, upon the wind speeds for which the wind turbine is designed.

DSP 78 may alter the input impedance of the control system to create the pulses of FIG. 11C by appropriately changing the pulse-width modulation (PWM) signals sent to buck converters 82. Such alteration may involve changing the duty cycle of the PWM signals during the pulses and in the interim time periods between the pulses. It will be understood by those skilled in the art that the shape of the power pulses illustrated in FIG. 11C is merely for purposes of illustration, and that the actual shape will typically not be precisely rectangular shapes, but will be shaped to have ramp up and ramp down slopes that vary depending upon the overall construction of the systems, as well as the pulsing.

One of the results of the pulsed power extraction technique illustrated in FIG. 11C is to extract a certain amount of the kinetic energy of the rotating blades of the turbine out of the turbine in pulses and to convert it to pulsed electrical energy. This pulsed extraction of the kinetic energy from the rotating blades causes the blades to slow down during the energy extraction periods and, assuming the wind continues to blow, to speed back up during the interim periods between pulses.

As was noted above, DSP 78 may be programmed to utilize the pulsed power extraction technique illustrated in FIG. 11C during low wind speed conditions. In such embodiments, DSP 78 may be programmed to check the wind speed detected by anemometer 50, compare it to a threshold value that defines a low-wind speed condition, and if the current wind speed exceeds the threshold, use the continuous power extraction technique illustrated in FIG. 11B. On the other hand, if the current wind speed is at or beneath the threshold, DSP will switch to a pulsed power extraction technique, such as that shown in FIG. 11C. Various forms of hysteresis may be used to help avoid excessive switching in variable speed winds at or near the threshold. Still further, in any of the embodiments, DSP 78 may be programmed to check to see if the wind speed exceeds a maximum wind speed threshold that is set higher than the low-wind speed threshold. Wind speeds above the maximum wind speed threshold may cause DSP 78 to rotate wind turbine 22 out of direct alignment with the wind, or to stop power generation completely.

In some embodiments, DSP 78 may switch between the continuous power extraction and pulsed power extraction techniques of FIGS. 11B and 11C based upon the voltage being generated by turbine 22, rather than a direct measurement of the wind speed. Other quantities besides voltage and wind speed may be utilized for switching between these power extraction techniques. Further, DSP 78's decision to switch between the pulsed and continuous power extraction techniques may alternatively be based, at least partially, upon the charge level status of the one or more connected batteries 58. For example, if a low wind speed is present and the batteries are fully charged,

In some embodiments, it may be desirable to not harvest any electricity from turbine 22 when the voltage generated by turbine 22 is below a threshold. As but one example, it may be desirable to not harvest any electricity when the wind speeds are such that turbine 22 can only generate less than fifty volts. Whatever the precise threshold, control system 24 may be programmed to allow turbine 22 to free spin when the wind speeds are such that the voltage is less than the threshold. Such a threshold will therefore be referred to herein as the free spin threshold. Still further, if the wind speeds increase such that more than fifty volts are able to be generated by wind turbine 22, but the wind speeds still qualify as low speeds (as discussed above with respect to FIG. 11C, then DSP 78 may be programmed to utilize the pulsed power extraction technique of FIG. 11C. In such a case, the length of each pulse may last until the voltage extracted decreases down to the free spin threshold. Once the free spin threshold is reached, the pulse of the power extraction will be discontinued until wind turbine has a chance to regain a sufficient speed for another pulse of power extraction.

One illustrative example of the pulsed power extraction technique described in the immediately preceding paragraph will be provided herein for purposes of better understanding the concepts. It will, of course, be understood by those skilled in the art that this description is merely exemplary, and that the precise values described can be changed. Suppose, for example, that it is desirable to have wind turbine 22 free spin at voltages of less than fifty volts. In those cases where the wind increases slightly above this free spin threshold, DSP 78 may be programmed to extract power from wind turbine 22 in a pulsed manner whereby each pulse lasts for the time it takes to bring the voltage back down to near or at the free spin threshold. For instance, DSP 78 may allow turbine to free spin up to 60 volts; then extract power in a pulse that lasts until the voltage drops to 50 volts; then allow turbine 22 to free spin again until 60 volts are reached again; then extract power again in another pulse until the voltage drops to 50 volts, and so on. The upper limit (in this case 60 volts) can vary, but may correspond to the threshold voltage that defines a low speed wind condition, as discussed above with respect to FIG. 11C. The duration or period of the pulse may vary with changes in the wind speed, or other factors that affect the length of time it takes for the voltage to drop to the free spin threshold.

In an alternative embodiment, the pulse period may be fixed, or it may vary based on other factors, such as wind speed, battery charge level, the electrical load, or other still other factors. With a fixed pulse period, DSP 78 may alter the PWM signals, thereby altering the input impedance, for a fixed amount of time, regardless of the drop in voltage caused thereby.

In still other embodiments, DSP 78 may extract power in a pulsed manner without allowing the wind turbine to free spin. In such cases, DSP 78 may vary the input impedance of control system 24 between levels that are alternatingly above and below the impedance of wind turbine 22. The lower impedance may not drop all the way to zero, or otherwise cause wind turbine 22 to free spin. Instead, the impedance may drop to a level that, while mismatched below the impedance of wind turbine 22, still causes electricity to be generated. Such an embodiment will alter the graph of FIG. 11C from a series of pulses spaced by intervening periods of zero power, to a series of pulses spaced by intervening periods of non-zero, but reduced (relative to the peaks), power.

It will be understood by those skilled in the art that the specific electronic and electrical components described in the aforementioned embodiments may be changed to other electrical components and electronics that perform similar functions. For example, the buck converters described herein may be replaced with other switching converters, or other converters that operate in a non-switched manner. Similarly, the control of the buck converters, or other types of converters, may be changed from that utilizing pulse width modulated signals to other types of control signals. Other modifications are also possible.

Any of the foregoing embodiments may also be modified to incorporate the structures, methods, and operation of any of the devices and systems disclosed in U.S. patent application Ser. No. 12/138,818 filed Jun. 13, 2008 and Ser. No. 12/698,640 filed Feb. 20, 2010, both of which are entitled “Turbine Energy Generating System,” both of which were filed by Imad Mahawili, Ph.D., and the complete disclosures of which are both hereby incorporated herein by reference.

While several forms of the invention have been shown and described, other forms will now be apparent to those skilled in the art. It should be understood that the embodiments shown in the drawings and described above are merely for illustrative purposes, and are not intended to limit the scope of the invention which is defined by the claims which follow as interpreted under the principles of patent law including the doctrine of equivalents.

What is claimed is:

1. A system for generating electricity from wind comprising:
a wind turbine having a plurality of blades adapted to rotate about an axis and to thereby generate an output voltage, said wind turbine having an electrical impedance; and
a control subsystem for said wind turbine, said control subsystem having a variable impedance controlled by a controller, wherein said controller is adapted to extract power from said wind turbine in a pulsed manner by changing said variable impedance of said control subsystem between levels that are below and above said electrical impedance of said wind turbine.

2. The system of claim 1 wherein said controller is further adapted, during at least one predetermined condition, to match said impedance of said control subsystem to said electrical impedance of said wind turbine such that power is extracted in a non-pulsed manner while said at least one predetermined condition is met.

3. The system of claim 2 wherein said at least one predetermined condition includes a wind speed that is less than a threshold wind speed.

4. The system of claim 1 wherein said controller stores an upper threshold voltage and a lower threshold voltage, and wherein said controller changes said variable impedance of said control subsystem based upon said output voltage of said wind turbine reaching said upper threshold and lower threshold voltages.

5. The system of claim 4 wherein said lower threshold voltage corresponds to a wind speed below which said wind turbine is designed to free spin.

6. The system of claim 1 wherein said control subsystem includes at least one buck converter and said controller is adapted to change said variable impedance by changing a duty cycle of a pulse width modulated signal sent to said at least one buck converter.

7. The system of claim 1 further including:
a first sensor for determining wind direction;
a second sensor for determining wind speed;
a motor adapted to change an orientation of said axis; and
wherein said controller is in communication with said first and second sensors and said controller is adapted to activate said motor such that said axis aligns with the wind direction when the wind speed is less than a set wind speed, and said controller is further adapted to activate said motor such that said axis is misaligned with the wind direction when the wind speed is greater than said set wind speed.

8. The system of claim 1 further including:
a voltage sensor for measuring said voltage output;
a buck converter in electrical communication with said wind turbine voltage output, said buck converter adapted to reduce a voltage level of said wind turbine voltage output;
an inverter adapted to convert direct current into alternating current;
a transfer switch adapted to selectively couple an output from said inverter or a utility-supplied source of electrical energy to a distribution panel;
a battery; and
wherein said controller is adapted to monitor a charge level of said battery and to switch said transfer switch to couple the utility-supplied source of electrical energy to said distribution panel when said charge level of said battery falls below a charge threshold and said output voltage falls below a voltage threshold.

9. A system for generating electricity from wind comprising:
a wind turbine having a plurality of blades adapted to rotate about an axis and to thereby generate an output voltage; and
a control subsystem for said wind turbine, said control subsystem adapted to extract electrical power from said wind turbine in a substantially continuous manner when a wind speed is less than a wind speed threshold, and said control subsystem adapted to extract electrical power from said wind turbine in a pulsed manner when the wind speed is greater than said wind speed threshold.

10. The system of claim 9 wherein said control subsystem includes a controller adapted to extract electrical power from said wind turbine in a pulsed manner by varying input impedances into said control subsystem in a pulsed manner.

11. The system of claim 10 wherein said controller varies input impedances into said control subsystem by varying a duty cycle of a pulse width modulated control signal that controls at least one buck converter.

12. The system of claim 10 wherein said controller is adapted to extract electrical power from said wind turbine in said substantially continuous manner by matching said input impedance into said control subsystem to an impedance of said wind turbine.

13. The system of claim 10 wherein said controller stores an upper threshold voltage and a lower threshold voltage, and wherein said controller changes said input impedance of said control subsystem based upon said output voltage of said wind turbine reaching said upper threshold and lower threshold voltages.

14. The system of claim 13 wherein said lower threshold voltage corresponds to a wind speed below which said wind turbine is designed to free spin.

15. A control system for a wind turbine having a plurality of blades adapted to rotate about an axis, said system comprising:
a first sensor for determining wind direction;
a second sensor for determining wind speed;
a motor adapted to change an orientation of said axis; and
a controller in communication with said first and second sensors, said controller adapted to activate said motor such that said axis aligns with the wind direction when the wind speed is less than a threshold, and said controller further adapted to activate said motor such that said axis is misaligned with the wind direction when the wind speed is greater than said threshold.

16. The system of claim 15 wherein said second sensor is an anemometer physically spaced away from said blades.

17. The system of claim 15 wherein said second sensor is a sensor adapted to measure a speed of the plurality of blades.

18. The system of claim 15 wherein said controller is further adapted to activate said motor such that an amount of misalignment of the axis and the wind direction increases with increases in wind speed above said threshold.

19. The system of claim 18 further including a voltage regulator adapted to supply a regulated voltage to both an inverter and a battery connector, said battery connector adapted to supply an electrical connection to one or more batteries.

20. The system of claim 15 wherein said blades of said wind turbine have a profile that occupies at least 70% of the circular area defined by the rotation of the blades.

21. The system of claim 20 wherein the wind turbine includes a plurality of magnets mounted adjacent an outer end of a plurality of said blades.

22. The system of claim 19 wherein said inverter is electrically coupled to a distribution panel adapted to supply electrical power to at least one circuit in a home or building.

23. The system of claim 22 wherein said controller is further adapted to automatically couple said battery to said distribution panel upon detecting a loss in the power supplied by a utility to the home or building.

24. The system of claim 23 wherein said controller is further adapted to monitor a charge level of said battery and prevent the battery from experiencing a deep cycle discharge except when said controller detects a loss in the power supplied by a utility to the home or building.

25. The system of claim 23 wherein said controller is further adapted to monitor a charge level of said battery perform the following:
(a) supply a substantially constant current to said battery until a threshold level of charge is reached; and
(b) supply a substantially constant voltage to said battery after said threshold level of charge is reached.

26. The system of claim 25 wherein said controller is further adapted to reduce said substantially constant voltage after a second threshold level of charge is reached.

27. The system of claim 15 wherein said controller is adapted to transmit electricity generated by said wind turbine directly to an inverter if a voltage of said generated electricity exceeds a threshold voltage.

28. A system for generating electricity from wind comprising:
a wind turbine having a plurality of blades adapted to rotate about an axis, said wind turbine adapted to generate a voltage output;
a voltage sensor for measuring said voltage output;
a buck converter in electrical communication with said wind turbine voltage output, said buck converter adapted to reduce a voltage level of said wind turbine voltage output;
an inverter adapted to convert direct current into alternating current;
a transfer switch adapted to selectively couple an output from said inverter or a utility-supplied source of electrical energy to a distribution panel;
a battery;
a controller in communication with said voltage sensor, said buck converter, said battery, and said transfer switch, said controller adapted to monitor a charge level of said battery, said controller further adapted to switch said transfer switch to couple the utility-supplied source of electrical energy to said distribution panel when said charge level of said battery falls below a charge threshold and said output voltage falls below a voltage threshold.

29. The system of claim 28 wherein said controller is further adapted to automatically switch said transfer switch to couple an output of said inverter to the distribution panel when said controller detects a loss of utility-supplied electrical power.

30. The system of claim 29 wherein said inverter is adapted to convert direct current into alternating current having a voltage of substantially 120 volts.

31. The system of claim 28 wherein said controller is further adapted to supply electrical energy from said wind turbine to a utility company if said controller detects that said battery has a full charge level and said distribution panel is not consuming all of the electrical energy from said wind turbine.

32. The system of claim 28 wherein said controller includes a display panel adapted to display at least the following information: wind speed, wind direction, battery charge level, cumulative energy generated to date, and voltage being supplied by said wind turbine.

33. The system of claim 28 wherein said controller is adapted to prevent said battery from experiencing a deep cycle discharge except when said controller detects the utility-supplied source of electrical energy is cut-off.
